(19) United States
(12) Patent Application Publication
(10) Pub. No.: US 2025/0056672 A1
(43) Pub. Date: Feb. 13, 2025

(54) ADAPTIVE STREET LIGHTING SYSTEM

(71) Applicant: WI4B S.R.L., Bologna (BO) (IT)

(72) Inventors: Andrea TOPPAN, Bologna (BO) (IT); Paolo TOPPAN, Bologna (BO) (IT); Rudy BANDIERA, Bologna (BO) (IT)

(21) Appl. No.: 18/720,515

(22) PCT Filed: Dec. 13, 2022
(86) PCT No.: PCT/IB2022/062117

§ 371 Date: Jun. 14, 2024

(30) Foreign Application Priority Data
Dec. 17, 2021 (IT) 102021000031628

(51) Int. Cl. H04W 84/22; H05B 47/125; H05B 47/175

(52) U.S. Cl. CPC H04W 84/22; H05B 47/125; H05B 47/1985

(57) ABSTRACT

The adaptive street lighting system (1) comprises a plurality of light members (2) positioned along a road network (R), wherein each of the light members is provided with one lighting element (3) adapted to illuminate one section of the road network, one adjusting device (4) configured to adjust the light intensity of the lighting element (3), one weather detecting unit (5) provided with a set of sensors (6) configured to detect weather data representative of the weather conditions in the proximity of the road network (R) and one traffic monitoring assembly (7) provided with one traffic sensor (8) configured to detect traffic data on the road network (R), wherein each of the light members (2), the weather detecting unit (5) and the monitoring assembly (7) comprises a related communication device (9) configured to define a transceiver network for the data, and wherein each of the light members (2) comprises at least one control device (10) configured to control in real time the adjusting device (4) to dim in real time the light intensity of the lighting element (3) depending on the data.

### TECHNICAL FIELD

The present invention relates to an adaptive street lighting system.

### BACKGROUND ART

It is well known that in recent years, in most industries, there is a frequent search for solutions which allow reducing energy expenditure and related environmental impact.

This need is also felt in the public lighting sector where road network lighting systems involve high electricity consumption, which is not always necessary.

Street lighting systems generally comprise a plurality of light members, commonly referred to as streetlights, which are activated by a remote control unit at pre-determined times, during the nighttime hours, to promote road visibility by vehicle drivers as well as pedestrians.

However, in known street lighting systems, the light members are activated regardless of the actual presence of vehicles in the road network leading to unnecessary energy expenditure.

At the same time, it may happen that, for example due to adverse weather conditions, visibility is also reduced during daylight hours. In such a case, a huge inconvenience for drivers is created because, during daylight hours, the light members are not activated or are specially activated by the remote control unit when needed, resulting in excessive delays and increasing the risk of traffic accidents.

To overcome some of these drawbacks, solutions are known that manage the activation of a light member exclusively when a vehicle or pedestrian passes by. In this way, sequential activation of the streetlights allows them to illuminate the road during the vehicle/pedestrian's path, while reducing energy consumption.

However, such solutions are limited in that they do not allow the lighting along a specific road section to be managed depending on the actual conditions on the road section, given, e.g., by traffic conditions, luminance, weather conditions and even the specific road category (e.g., main suburban, secondary suburban, urban slip road, urban neighborhood road) or traffic category.

Known solutions, therefore, cannot guarantee the demanded safety requirements according to the specific conditions of each specific road section.

### DESCRIPTION OF THE INVENTION

The main aim of the present invention is to devise an adaptive street lighting system which allows adjusting the activation of street lighting while reducing energy expenditure and meeting the demanded safety requirements on each specific road section.

Another object of the present invention is to devise an adaptive street lighting system that allows quick and precise intervention on the light members and avoids dangerous delays.

Another object of the present invention is to devise an adaptive street lighting system that allows the mentioned drawbacks of the prior art to be overcome within the framework of a simple, rational, easily and effectively deployed as well as cost-effective solution.

Another object of the present invention is to devise an adaptive street lighting system that does not involve the use of broadband communication channels towards centralized systems to carry out the function thereof.

The aforementioned objects are achieved by this adaptive street lighting system having the characteristics of claim 1.

### BRIEF DESCRIPTION OF THE DRAWINGS

Other characteristics and advantages of the present invention will become more apparent from the description of a preferred, but not exclusive, embodiment of an adaptive street lighting system, illustrated by way of an indicative, yet non-limiting example, in the accompanying tables of drawings in which:

FIG. 1 is a schematic plan representation of a street lighting system according to the invention installed on a road network;

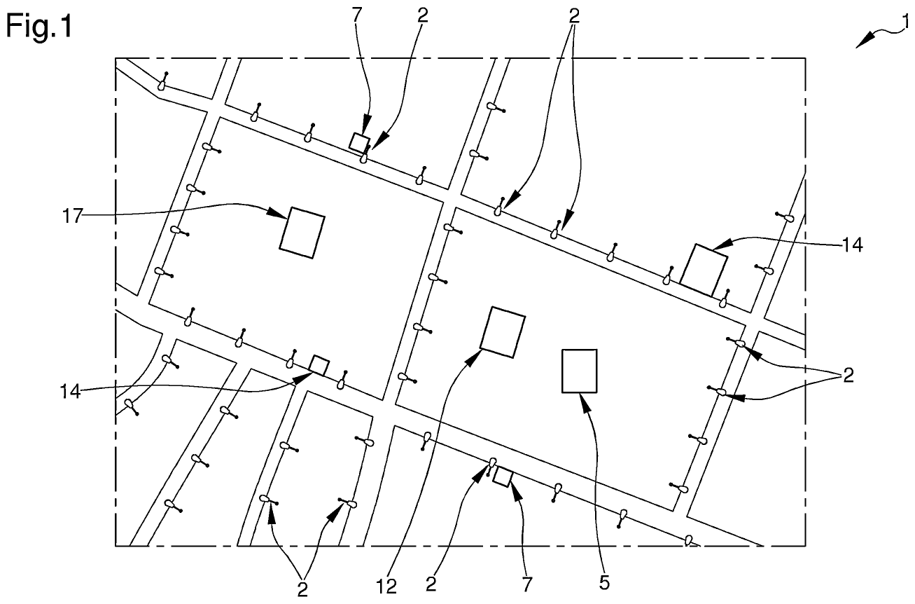

FIG. 2 is a perspective view of the lighting system according to the invention in a section of road network;

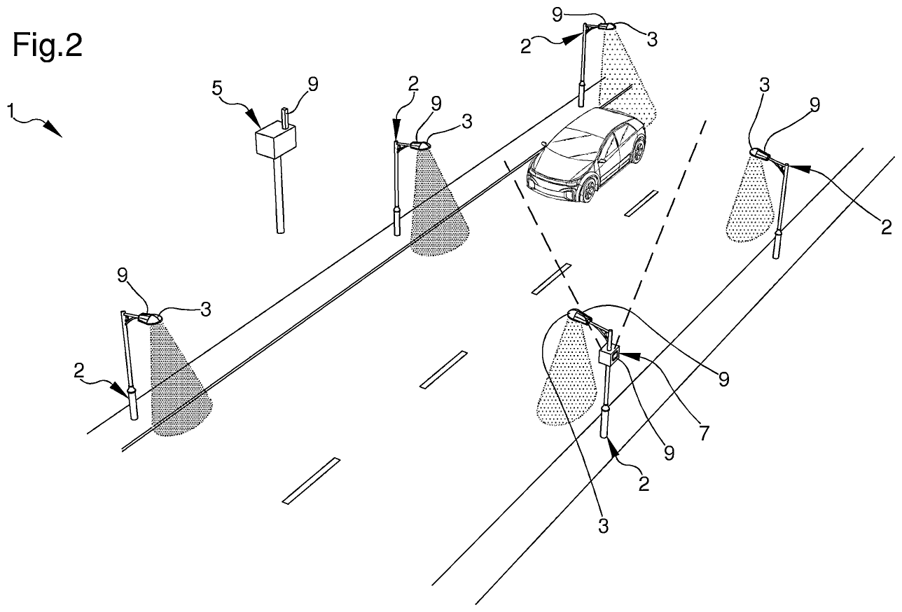

FIG. 3 is a block representation of the lighting system according to the invention.

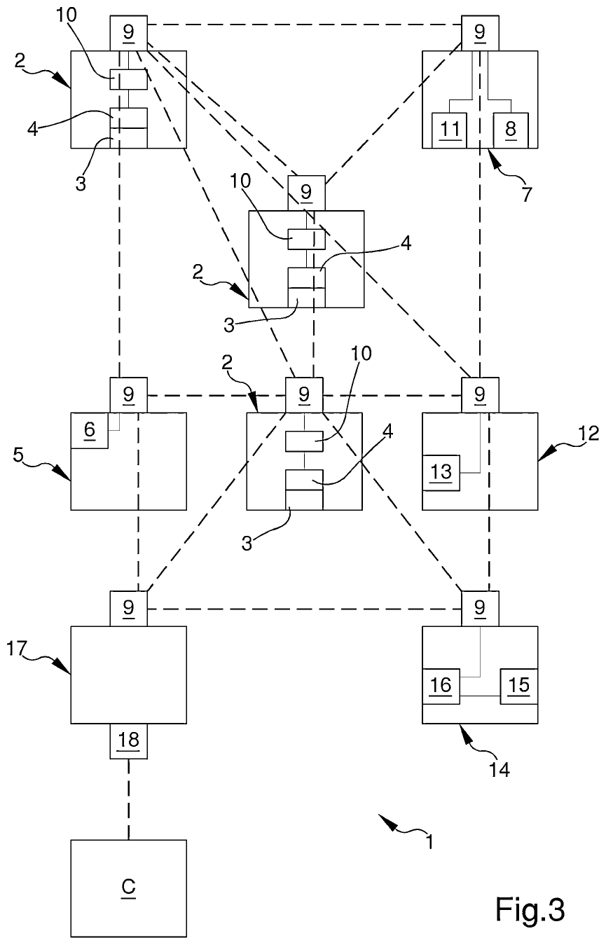

### EMBODIMENTS OF THE INVENTION

With particular reference to these figures, reference numeral 1 globally indicates an adaptive street lighting system.

The system 1 according to the invention comprises a plurality of light members 2 arranged along a road network R.

The number of light members 2 and their arrangement are chosen depending on the type of road network and on the usual traffic conditions.

Each of the light members 2 is provided with:
—at least one lighting element 3 adapted to illuminate at least one section of the road network; and
at least one adjusting device 4 configured to adjust the light intensity of the lighting element 3.

The lighting element 3 may consist of a single lamp or of a set of several lamps.

At the same time, such lamps may be LED, halogen or similar types.

The adjusting device 4 is of the type of a dimmer.

The light member 2 can be powered through the power grid or by means of devices capable of exploiting a renewable energy source such as, e.g., photovoltaic panels or wind turbines.

The system 1 also comprises at least one weather detecting unit 5 provided with a set of sensors 6 configured to detect weather data representative of the weather conditions in the proximity of the road network R.

For example, the detected weather data comprise weather conditions such as rain, snow, hail and fog. Detection of additional weather data is possible, such as: amount and direction of wind, amount of rain.

The set of sensors 6 may comprise, e.g., special weather sensors configured to detect weather conditions or an image acquisition system configured to monitor such conditions by means of image recording.

The system 1 is configured to exploit weather data in order to optimize the adjustment of the light intensity of the lighting element 3, as will be better explained later in this disclosure. In other words, in case of weather conditions that may impair visibility for drivers of vehicles passing through the road network, the system 1 allows the light intensity of the lighting element 3 to be increased and vice versa.

The system 1 also comprises at least one traffic monitoring assembly 7 provided with at least one traffic sensor 8 configured to detect traffic data on the road network R.

Similarly to the above, the system 1 is configured to take advantage of traffic data in order to optimize the light intensity adjustment of the lighting element 3. In other words, when there is heavy traffic on the road network, the system 1 allows the light intensity of the lighting element 3 to be increased and vice versa.

Each of the light members 2, the weather detecting unit 5 and the monitoring assembly 7 comprise a related communication device 9 configured to define a data transceiver network.

According to a preferred embodiment, the communication device 9 is of the wireless mesh type and is configured to define a data transceiver mesh network. As known to the industry technician, a mesh network is a local network type in which the infrastructure nodes, i.e., the various components of the network itself, connect directly and dynamically to as many nodes as possible and operate in conjunction with each other to route data in an efficient manner.

The mesh network always ensures optimal connection between the various components of the network itself, since each device is able to forward the signal to additional devices, thus being able to avoid obstacles and always ensuring at least one valid communication path between one point and another in the network.

The communication distance between one point and another can be up to 1 km, thus ensuring for each re-launch considerable distances and covering all scenarios that can occur in an urban setting.

More specifically, in a mesh network, the various components of the network itself simultaneously serve as receivers, transmitters and repeaters. This results in a network capable of covering even very large distances.

In addition, this type of network is decentralized and does not require data processing by a remote control unit allowing real-time communication between the components.

Each of the light members 2 also comprises at least one control device 10 configured to control in real time the adjusting device 4 to dim in real time the light intensity of the lighting element 3 depending on the data from the roadside set of sensors.

Thus, thanks to the mesh network, all information is processed at the road network level in real time, so that the adjustment of the lighting of the light members 2 is not subject to delays due to the communication with a remote control unit and to the data processing by the latter.

Advantageously, the monitoring assembly 7 is associated with at least one of the light members 2.

In this way, traffic detection is also carried out in real time and the detected traffic data is extremely accurate and reliable.

For this purpose, the system 1 may comprise a plurality of monitoring assemblies 7 installed at different sections of the road network R.

The monitoring assembly 7 also comprises radar sensors 11 configured to detect the travel data of the vehicles and possibly bicycles and/or pedestrians on the road network R.

It cannot, however, be ruled out that the monitoring assembly 7 comprise a set of sensors of a different type which is configured to detect the travel data.

The monitoring assembly 7, therefore, not only makes it possible to detect the number of vehicles passing through the road network but also the actual movement of the same. The monitoring assembly 7, therefore, allows for real-time information on the traffic flow.

The communication device 9 of the monitoring assembly 7 is, in fact, configured to transmit the movement data through the mesh network as well. Advantageously, the system 1 also comprises at least one luminance detecting unit 12 provided with at least one luminance sensor 13 configured to detect luminance data representative of the light intensity of the surrounding environment.

The luminance sensor 13 can detect the actual brightness of the surrounding environment so that the brightness adjustment of the lighting element 3 is accurate and reliable.

The luminance detecting unit 12 in turn also comprises a communication device 9 of the wireless mesh type configured to transmit the luminance data through the mesh network.

The light members 2 are, therefore, configured to receive and process luminance data in real time as well.

Usefully, the system 1 may also comprise at least one image acquisition and processing unit 14 provided with at least one acquisition device 15 configured to acquire images relating to at least one section of the road network R.

The image acquisition and processing unit 14 also comprises one communication device 9 of the wireless mesh type configured to transmit processed metadata relating to the images (e.g., traffic, weather, traffic classification, etc. . . . ) through the mesh network.

For this purpose, the image acquisition and processing unit 14 also comprises an edge computing unit 16 configured to process the images acquired by the acquisition device 15 and to generate the aforementioned metadata.

Specifically, the acquisition device 15 is of the optical sensor type configured to acquire videos of the road network.

The video acquired by the acquisition device 15 and processed in edge computing by means of the edge computing unit 16 provides additional detailed information relating to the traffic status, weather conditions, luminance and, if required, allows additional parameters to be detected.

The processed metadata of the images can, therefore, be sent to the light members 2 to dim the lighting element 3 in real time.

Appropriately, the system 1 may comprise a plurality of image acquisition and processing units 14 installed at different sections of the road network R.

The system 1 then comprises at least one control unit 17 positioned at the point where the road network R is located and configured to control the system itself. For this purpose, the control unit 17 comprises, in turn, a communication device 9 of the wireless type configured to transmit/receive data through the network. According to a preferred embodiment, the communication device 9 of the control unit 17 is of the wireless mesh type and is configured to transmit/receive data through the mesh network.

Advantageously, the control unit 17 is configured to acquire in real time and process the following information related to each specific road section of the road network R considered for the provision of adaptive lighting:
information regarding the type of the specific road section considered;
weather data representative of the weather conditions in the proximity of the specific road section considered, detected by the relevant weather detecting units 5;
the luminance value measured on the road surface of the specific road section considered by the relevant luminance sensor 13;
traffic data detected along the specific road section considered by the relevant traffic sensor 8, comprising traffic density, meant as the amount of vehicles passing along each roadway, for each direction of travel.

Specifically, information on the type of the specific road section considered comprises:
road category (e.g., main suburban, secondary suburban, urban slip road, urban neighborhood road);
traffic categories: depending on the road category, several traffic categories are provided (e.g. pedestrian road);
design speed range (e.g., straight, circular curves, variable radius curves);
number of lanes per roadway.

With reference to the traffic data, optionally the control unit 17 is configured to estimate the traffic density for each traffic category (e.g., number of cars, number of articulated vehicles, number of motorcycles, with a traffic classification in the seven categories: articulated vehicle, truck with trailer, van, car, motorcycle, cyclist, pedestrian).

“Static” information regarding the type of the specific road section considered, for each road section considered, can be saved directly within the individual control device 10 of each lighting element 3.

Real-time information, relating to weather data, luminance value and traffic data, is acquired through the appropriate roadside sensors for each road section considered.

It is easy to appreciate how a real time data network is required that is able to make the roadside lamps and the sensors communicate, without communication delays and without there being any processing delay between the roadside control unit and the lamps. For this reason, the wireless network must be with low delay.

The information of weather data, luminance value and traffic data can be acquired with varying granularity, which can go as far as sending and receiving each piece of information every second, and is dependent on the adaptive design being defined. Each project (which can refer to each road) can have different granularities of acquisition.

Each adaptive project can be considered with one project independent of the others. An adaptive project involves the provision of adaptive lighting on a specific road category, and will evaluate the real-time data associated with that road section independently from the other projects.

Advantageously, the control unit 17 is configured to calculate the correct lighting level of each light member 2 on each road section of the road network R, depending on the information about the type of each road section, weather data representative of the weather conditions in the proximity of each road section and the luminance value measured on the road surface of each road section.

The control unit 17 is operationally connected to the adjusting device 4 of each light member 2 to dim the light intensity of the lighting element 3 in real time depending on the correct lighting level calculated.

The algorithm implemented within the control unit 17 by which the correct lighting level is to be defined, depending on the previously described parameters, can be summarized as a set of rules that maintain the correct light level by making dynamic the definition of the road category (and thus the minimum light level that must be ensured to maintain unchanged road safety on that road section), which mainly depends on the number of cars that is passing at that precise instant, as well as on the weather and luminance conditions. Preferably, evaluation of the traffic density parameter is obtained by means of a moving window, which can acquire data in a variable time window, on the order of a few minutes, and is therefore strong enough to sudden changes in traffic density.

The result is a very gradual and imperceptible change in the light level on the road, through also the use of fade-in and fade-out procedures between light levels, where the new light level is the result of the joint assessment of all the parameters of the road type and of the previously described environmental parameters.

The new light level to be provided can never be higher (or lower) than a certain (customizable) percentage with respect to the previous light level, and only maintenance of the real time parameters over time will gradually lead to a significant change in the light level on the road surface.

Therefore, a light level can be provided on each road that depends on the environmental conditions (meant as weather, luminance, traffic density) and on the road safety assessment of that road section, which depends on its classification (meant as the assessment of the “road category” parameter and, optionally, the joint assessment of the other parameters, such as “traffic categories”, “design speed range”, “number of lanes per roadway”).

The control unit 17 also comprises at least one wireless communication unit 18 configured to transmit/receive data to/from a remote control unit C.

Thanks to the control unit 17, the data collected by the set of sensors of the system 1 are sent to and controlled by the remote control unit C. The control unit 17 locally supervises the status of the system 1 and sends any abnormal signals to the remote control unit C.

The system 1 is also configured to receive data from the remote control unit C and transmit it to the various components through the mesh network. For example, through the remote control unit C, the system 1 can receive signals regarding predetermined time slots in which to activate the light members 2 or to correct the aforementioned possible anomalies.

The control unit 17 is also configured to assign a queuing discipline to the network data and the relevant communication device 9 is configured to send that data according to the queuing discipline. In other words, the control unit 17 assigns a priority level to the data so that data with a higher priority level is transmitted faster.

It is in practice been ascertained that the described invention achieves the intended objects, and in particular, the fact is emphasized that the mesh communication network of the adaptive street lighting system according to the invention enables real-time adjustment of the street lighting activation while reducing energy expenditure and the related environmental impact.

In addition to this, the street lighting system enables quick and precise intervention on the light members, thus avoiding dangerous delays.

The invention described allows for better tracking of traffic patterns, without delays due to the communication towards remote systems that must process data in real time and resend it to the roadside. This improves the achievable savings and performance of the system itself.

In addition, the system is extremely strong in that, in the event of a lack of communication towards the remote systems, proper operation is guaranteed. This is even more valid in its installation in areas with poor connectivity, such as mountainous areas or rural villages.

Finally, the present street lighting system allows the light intensity emitted by the light members to be adjusted according to the actual need.

1. Adaptive street lighting system (1), characterized by the fact that it comprises:
a plurality of light members (2) positioned along a road network (R), wherein each of said light members is provided with:
at least one lighting element (3) adapted to illuminate at least one section of said road network;
at least one adjusting device (4) configured to adjust the light intensity of said lighting element (3);
at least one weather detecting unit (5) provided with a set of sensors (6) configured to detect weather data representative of the weather conditions in the proximity of said road network (R); and
at least one traffic monitoring assembly (7) provided with at least one traffic sensor (8) configured to detect traffic data on said road network (R);
wherein each of said light members (2), said weather detecting unit (5) and said monitoring assembly (7) comprises a related communication device (9) configured to define a transceiver network for said data;
and wherein each of said light members (2) comprises at least one control device (10) configured to control in real time said adjusting device (4) to dim in real time the light intensity of said lighting element (3) depending on said data.

2. System (1) according to claim 1, characterized by the fact that said communication device (9) is of the wireless mesh type and is configured to define a transceiver mesh network of said data.

3. System (1) according to claim 1, characterized by the fact that said monitoring assembly (7) is associated with at least one of said light members (2).

4. System (1) according to claim 1, characterized by the fact that said monitoring assembly (7) comprises radar sensors (11) configured to detect the movement data on said road network (R), said communication device (9) being configured to transmit said movement data through said mesh network.

5. System (1) according to claim 1, characterized by the fact that it comprises at least one luminance detecting unit (12) provided with at least one luminance sensor (13) configured to detect luminance data representative of the light intensity of the surrounding environment and a communication device (9) of the wireless mesh type configured to transmit said luminance data through said mesh network.

6. System (1) according to claim 1, characterized by the fact that it comprises at least one image acquisition and processing unit (14) provided with at least one acquisition device (15) configured to acquire images relating to at least one section of said road network (R) and with a communication device (9) of the wireless mesh type configured to transmit processed metadata relating to said images through said mesh network.

7. System (1) according to claim 1, characterized by the fact that said image acquisition and processing unit (14) comprises an edge computing unit (16) configured to process the images acquired by said acquisition device (15) and to generate said metadata.

8. System (1) according to claim 1, characterized by the fact that it comprises at least one control unit (17), positioned at the point where said road network (R) is located and configured to process the following information related to each specific road section considered of the road network (R):
information regarding the types of a specific road section considered;
the weather data representative of the weather conditions in the proximity of the specific road section considered, detected by the relevant weather detecting units (5);
the luminance value measured on the road surface of the specific road section considered by the relevant luminance sensor (13);
the traffic data detected along the specific road section considered by the relevant traffic sensor (8), comprising traffic density, meant as the amount of vehicles passing along each roadway, for each direction of travel.

9. System (1) according to claim 8, characterized by the fact that said information on the type of the specific road section considered comprises:
road category;
traffic categories;
design speed range;
number of lanes per roadway.

10. System (1) according to one or more of claims 8 and 9, claim 8, characterized by the fact that said control unit (17) is configured to calculate the correct lighting level of each light member (2) on each road section of the road network (3), depending on the information about the type of each road section, weather data representative of the weather conditions in the proximity of each road section, and the luminance value measured on the road surface of each road section.

11. System (1) according to claim 10, characterized by the fact that said control unit (17) is operationally connected to said adjusting device (4) of each light member (2) to dim the light intensity of said lighting element (3) in real time depending on the correct lighting level calculated.

12. System (1) according to claim 10, characterized by the fact that said control unit (17) comprises at least one communication device (9) of the wireless mesh type configured to transmit/receive data through said mesh network.

13. System (1) according to claim 10, characterized by the fact that said control unit (17) comprises at least one wireless communication unit (18) configured to transmit/receive data to/from a remote control unit (C).
